(19) United States
(12) Patent Application Publication
(10) Pub. No.: US 2013/0072242 A1
(43) Pub. Date: Mar. 21, 2013

(54) WIRELESS TRANSMISSION DEVICE, WIRELESS RECEPTION DEVICE, AND BANDWIDTH ALLOCATION METHOD

(71) Applicants: Takashi Iwai, Ishikawa (JP); Akihiko Nishio, Kanagawa (JP); Daichi Imamura, Kanagawa (JP); Seigo Nakao, Kanagawa (JP); Yoshihiko Ogawa, Kanagawa (JP); Shozo Okasaka, Kanagawa (JP); Masaru Fukuoka, Ishikawa (JP)

(72) Inventors: Takashi Iwai, Ishikawa (JP); Akihiko Nishio, Kanagawa (JP); Daichi Imamura, Kanagawa (JP); Seigo Nakao, Kanagawa (JP); Yoshihiko Ogawa, Kanagawa (JP); Shozo Okasaka, Kanagawa (JP); Masaru Fukuoka, Ishikawa (JP)

(73) Assignee: PANASONIC CORPORATION, Osaka (JP)

(21) Appl. No.: 13/520,865

(22) PCT Filed: Jan. 7, 2011
(86) PCT No.: PCT/JP2011/000043

§ 371 Date: Jul. 6, 2012

(30) Foreign Application Priority Data
Jan. 8, 2010 (JP) 2010-003154

(51) Int. Cl. H04W 72/04

(52) U.S. Cl. CPC H04W 72/0406
USPC 455/509

(57) ABSTRACT

Provided are a wireless transmission device, a wireless reception device, and a bandwidth allocation method for, when non-contiguous bands allocation is performed, improving the frequency resource use efficiency of a system and thereby improving the system performance. RIV decoding unit (106) decodes start RBG# and end RBG# that are indicated by each RIV output from scheduling information decoding unit (104). Allocation boundary setting unit (107) previously adds a predetermined predetermined offset to the boundary of each RIV so that the boundaries of the allocations of respective RIVs are different from each other. Based on the start RBG# and end RBG# output from RIV decoding unit (106) and the boundaries of the allocations of respective RIVs output from allocation boundary setting unit (107), transmission bandwidth determination unit (108) determines, as allocated bandwidths, the bandwidths that are indicated by a plurality of RIVs and are not overlapped with each other.

### TECHNICAL FIELD

The present invention relates to a radio transmission apparatus, a radio reception apparatus, and a band allocation method that allocate non-contiguous bands.

### BACKGROUND ART

The upstream channel of 3GPP LTE (3rd Generation Partnership Project Long Term Evolution) employs contiguous band transmission in which a data signal of each terminal is allocated to contiguous frequency band to reduce CM/PAPR (Cubic Metric/Peak to Average Power Ratio). Each terminal transmits data according to frequency allocation resource information notified from a base station. The frequency allocation resource information means two pieces of information that include a start RB (Resource Block) number and an end RB number where the term “RB” indicates a frequency allocation unit formed of twelve subcarriers.

In an LTE network, the base station notifies the terminals of the frequency allocation resource information using information referred to herein as RIV (Resource Indication Value). RIV indicates the allocation resource information with a tree structure as shown in FIG. 1. FIG. 1 shows the RIV tree structure that indicates contiguous band allocation within RB#0 to RB#5. When the base station designates RIV=6, for example, the allocation resource information for the terminal includes RB#0 and RB#1 that are the base of the tree. Similarly, when the base station designates RIV=14, allocation resource information for the terminal includes RB#2 to RB#4 that are the base of the tree. RB#0 to RB#5 located at the base of the tree correspond to RIVs=0 to 5, respectively.

Assuming that RIVs=0 to 5 at the base of the tree are the first step, RIVs=6 to 10, RIVs=12 to 15, RIVs=18 to 20, RIVs=17 to 16, and RIV=11 correspond to the second, third, fourth, fifth, and sixth steps, respectively. Utilization of the first to sixth RIVs enables the contiguous band with twenty-one patterns to be indicated out of RB#0 to RB#5 located at the base of the tree.

It is studied that the upstream channel of LIE-Advanced as an evolved form of LTE employs non-contiguous band transmission in addition to the contiguous band transmission to improve sector throughput performance (see Non-Patent Literature 1).

The non-contiguous band transmission is a transmission method of allocating data signals and reference signals to non-contiguous bands that are distributed over a wide band. The non-contiguous band transmission can allocate the data signals and the reference signals to discrete frequency bands as shown in FIG. 2. Thus, the non-contiguous band transmission can increase the degree of freedom of frequency band allocation of the data signal and the reference signal at each terminal to have a larger frequency scheduling effect compared to the contiguous band transmission.

A conventional method of sending the non-contiguous band allocation resource information from the base station to the terminals is to notify any terminal of the non-contiguous band allocation by sending a plurality of RIVs (contiguous band allocation information) to the terminal (see Non-Patent Literature 2).

As shown in FIG. 3, NPL 2 discloses that RBG numbers (RBG#) are assigned by allocation granularity (4 RB in FIG. 3) referred to herein as RBG (Resource Block Group) and the scheduled terminal is notified of RIV indicating a start RBG# and an end RBG#. The base station notifies the terminal of two RIVs (RIV#1 and RIV #2) as shown in FIG. 3, thereby enabling allocation of two clusters (each being a contiguous band block), i.e., non-contiguous bands to the terminal. Thus, specifying RBG by taking advantage of RIVs themselves used in conventional LTE enables non-contiguous band allocation to be easily introduced into LTE-Advanced.

An RBG size is determined according to a system bandwidth as shown in FIG. 4. For the system bandwidth of 20 MHz, for example, the RBG size will be 4 RB as shown in FIG. 3. The number of signaling bits of the allocation resource information is thus reduced by increasing RBG size according to the magnitude of the system bandwidth.

### CITATION LIST

### Non-Patent Literature

### NPL 1

R1-090257, Panasonic, “System performance of uplink non-contiguous resource allocation”

### NPL 2

### R1-093391, Samsung, “Control Signaling for Non-Contiguous UL Resource Allocations”

### SUMMARY OF INVENTION

### Technical Problem

However, the conventional non-contiguous band allocation method using a plurality of RIVs decreases the usage efficiency of system frequency resources to impair system performance due to coarse allocation granularity.

In the upstream channel of LTE, for example, control signals (PUCCHs) with the bandwidth of 1 RB are transmitted at both ends of the system band. FIG. 5 shows that PUCCHs sent from two terminals are multiplexed and occupy 2 RB resources. As shown in FIG. 6, a method of allocating the 1 RB granularity to limit a contiguous band may also send VoIP signals with 1 to 3 RB band widths within any band of the system band.

Thus, if contiguous band allocation signals of one RB granularity are less than the number of RBs consisting of RBG as a non-contiguous band allocation unit, unused resources less than one RBG occur as shown in FIG. 5 and FIG. 6. The conventional method of allocating non-contiguous band cannot allocate frequency resources less than one RBG that occurs as noted above to the terminal due to the allocation granularity of RBG unit. Therefore the usage efficiency of the system frequency resources decreases and the system performance deteriorates.

An object of the present invention is to provide a radio transmission apparatus, a radio reception apparatus, and a band allocation method that improve the usage efficiency of the system frequency resources and increase the system performance in allocation of non-contiguous bands.

### Solution to Problem

According to the present invention, a radio transmission apparatus includes: a receiver configured to receive a plurality of continuous band allocation information indicating allocation of continuous bands; a transmission band setting unit configured to set allocation unit boundaries of a plurality of bands allocated using the plurality of continuous band allocation information such that the allocation unit boundaries of the plurality of bands differ from each other, and set a band where the plurality of bands indicated by the plurality of continuous band allocation information do not overlap, as a transmission band based on the different allocation unit boundaries; and a transmitter configured to transmit transmission data on the set transmission band.

According to the present invention, a radio reception apparatus includes: a receiver configured to receive signals transmitted from a communication counterpart; a band setting unit configured to set allocation unit boundaries of a plurality of bands allocated using a plurality of continuous band allocation information such that the allocation unit boundaries of the plurality of bands differ from each other, and set a band where the plurality of bands indicated by the plurality of continuous band allocation information do not overlap, as an allocation band based on the different allocation unit boundaries; and an extractor configured to extract the received signals on the set allocation band.

According to the present invention, a band allocation method includes: setting allocation unit boundaries of a plurality of bands allocated using a plurality of continuous band allocation information indicating continuous band allocation, such that the allocation unit boundaries of the plurality of bands differ from each other; and determining a band where the plurality of bands indicated by the plurality of continuous band allocation information do not overlap, as a transmission band based on the set allocation unit boundaries.

### Advantageous Effects of Invention

According to the present invention, the usage rate of system frequency resources improves and the performance of the system can improve in allocation of non-contiguous bands.

### BRIEF DESCRIPTION OF DRAWINGS

FIG. 1 shows a tree structure of RIVs;

FIG. 2 shows contiguous band allocation and non-contiguous band allocation;

FIG. 3 shows non-contiguous band allocation using a plurality of RIVs disclosed in NPL 2;

FIG. 4 indicates the relationship between system bandwidth and RBG size;

FIG. 5 illustrates a transmission mode of PUCCHs at both ends of the system band;

FIG. 6 illustrates a transmission mode of VoIP signals within any band of the system bands;

FIG. 7 is a block diagram illustrating the configuration of a terminal according to Embodiment 1 of the present invention;

FIG. 8 is a block diagram illustrating the configuration of a base station according to Embodiment 1 of the present invention;

FIG. 9 illustrates the definition of allocation unit boundaries of each RIV;

FIG. 10 illustrates allocation bands where bands indicated by RIVs overlap with each other;

FIG. 11 illustrates allocation bands where bands indicated by RIVs do not overlap with each other;

FIG. 12 illustrates a band less than one RBG which is allocated even if PUCCHs are sent at both ends of the system band;

FIG. 13 illustrates a band less than one RBG which is allocated even if VoIPs are sent at the center of the system band;

FIG. 14 illustrates an RIV which can also indicate a band beyond one end of the system band;

FIG. 15 is a block diagram illustrating the configuration of a terminal according to Embodiment 2 of the present invention;

FIG. 16 illustrates non-contiguous band allocation where the allocation unit boundaries of the RIVs are aligned;

FIG. 17 is a block diagram illustrating the configuration of a terminal according to Embodiment 3 of the present invention;

FIG. 18 illustrates bands where the designation using RIV is restricted;

FIG. 19 illustrates a cyclic shift of the set range of RIV within the system band; and

FIG. 20 illustrates non-contiguous band allocation using three RIVs.

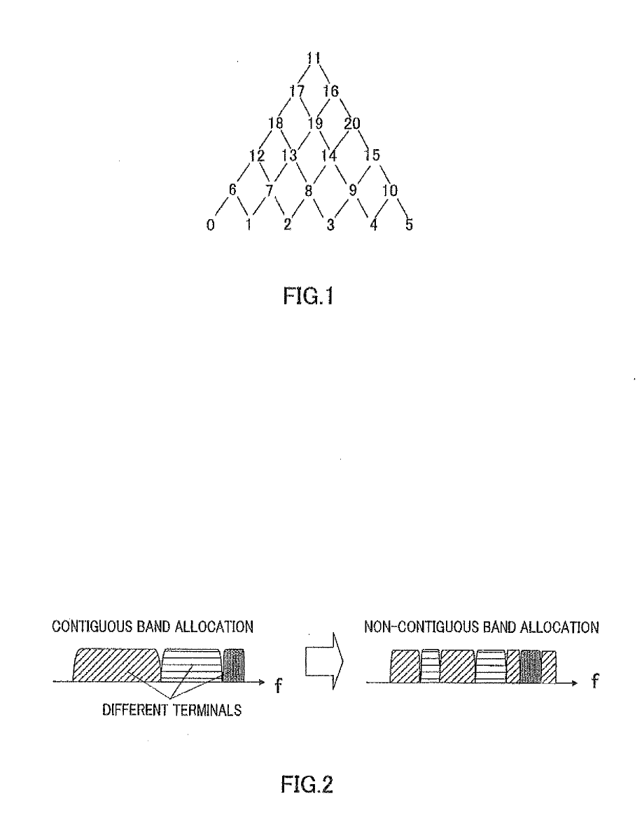

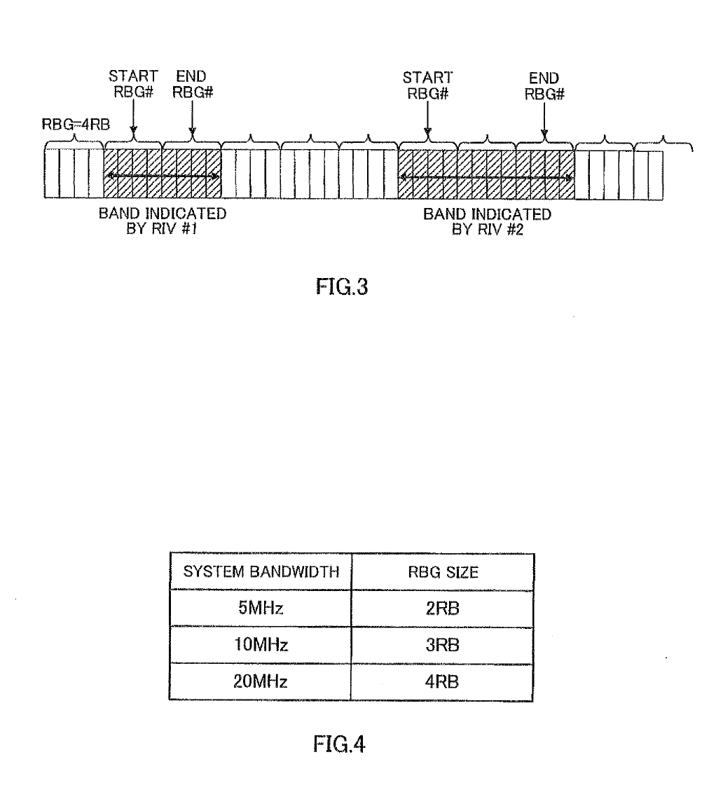

### DESCRIPTION OF EMBODIMENTS

Embodiments of the present invention will now be described in detail with reference to drawings. Components having the same functions in the embodiments are denoted by the same reference numerals, and their descriptions are omitted.

### Embodiment 1

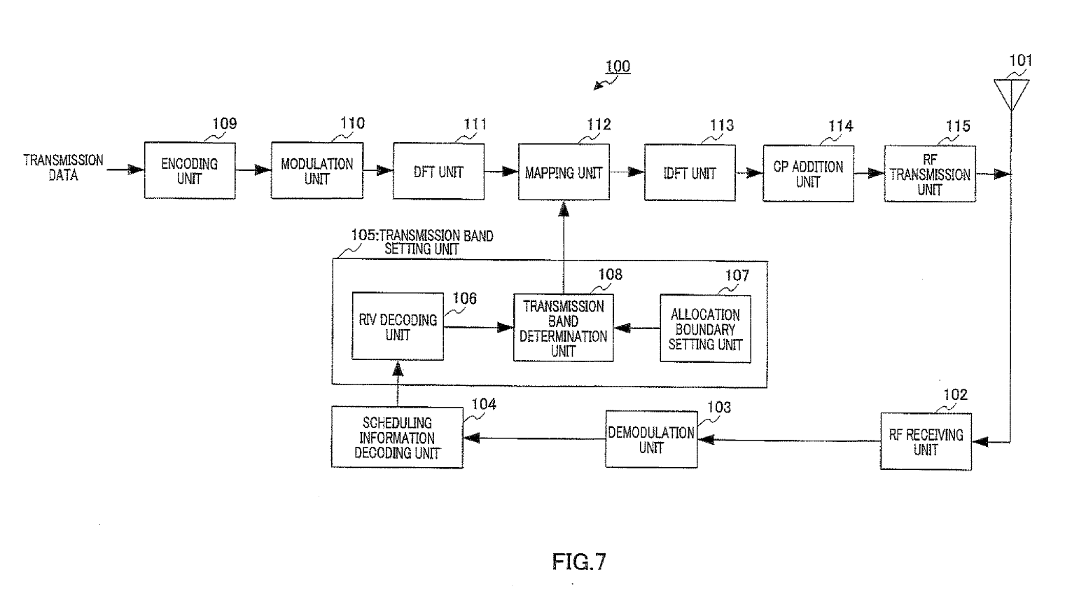

FIG. 7 is a block diagram illustrating the configuration of radio communication terminal apparatus (referred to merely as “terminal” hereinafter) 100 according to Embodiment 1 of the present invention. The configuration of terminal 100 is described below with reference to FIG. 7.

RF reception unit 102 receives signals from a radio communication base station apparatus (referred to merely as a “base station” hereinafter) through antenna 101, performs reception processing such as down-conversion and AID conversion for the received signals, and outputs the processed received signals to demodulation unit 103.

Demodulation unit 103 demodulates scheduling information from the base station that is included in the received signals output from RF reception unit 102, and outputs the demodulated scheduling information to scheduling information decoding unit 104. The scheduling information includes, for example, frequency allocation information, data size, power conditioner information, and the amount of cyclic shift for a reference signal of transmission data including RIV (contiguous band allocation information).

Scheduling information decoding unit 104 decodes the scheduling information output from demodulation unit 103, and outputs a plurality of RIVs included in the decoded scheduling information to the RIV decoding unit of transmission band setting unit 105.

Transmission band setting unit 105 is provided with RIV decoding unit 106, allocation boundary setting unit 107, and transmission band determination unit 108. Transmission band setting unit 105 sets a transmission band to which transmission data from terminal 100 is allocated based on the plurality of RIVs output from scheduling information decoding unit 104, and notifies mapping unit 112 of the set transmission band. The detail of transmission band setting unit 105 will be described later.

RIV decoding unit 106 decodes a start RBG# and an end RBG# indicated by each RIV output from scheduling information decoding unit 104 based on an RIV tree shown in FIG. 1, and outputs the decoded start RBG# and end RBG# to transmission band determination unit 108.

Allocation boundary setting unit 107 outputs allocation unit boundaries of each RIV to transmission band determination unit 108. Here, a predetermined offset is applied to the boundaries of each RIV in advance such that the allocation unit boundaries of each RIV are made different from each other. The predetermined offset is predetermined in the system. The offset may be a fixed value, or the base station may notify a terminal in a cell of the predetermined offset included in the system information.

Transmission band determination unit 108 determines a band indicated by each RIV based on the start RBG# and the end RBG# indicated by the RIV output from RIV decoding unit 106, and the allocation unit boundaries of the RIV output from allocation boundary setting unit 107. Transmission band determination unit 108 determines bands where the bands indicated by RIVs do not overlap as allocation bands, and outputs the determined allocation band information to mapping unit 112.

Encoding unit 109 encodes transmission data, and outputs the encoded data to modulation unit 110. Modulation unit 110 modulates the encoded data from encoding unit 109, and outputs the modulated data signals to DFT (Discrete Fourier Transform) unit

DFT unit 111 performs DFT processing for the data signals from modulation unit 110, and outputs the data signals in the frequency domain where the DFT processing is performed to mapping unit 112.

Mapping unit 112 maps the data signals output from the DFT unit to frequency-domain resources according to the allocation band information from transmission band determination unit 108, and outputs the mapped data signals to IDFT (Inverse Discrete Fourier Transform) unit 113.

IDFT unit 113 performs IDFT processing for the signals output from mapping unit 112, and outputs the IDFT-processed signals to CP (Cyclic Prefix) addition unit 114.

CP addition unit 114 adds the same signal as the tail portion of the signals output from IDFT unit 3 to the head of the signals as a CP, and outputs them to RF transmission unit 115.

RF transmission unit 115 performs transmission processing such as D/A conversion, up-conversion, and amplification for the signals output from CP addition unit 114, transmits the signals for which the transmission processing is performed, through antenna 101.

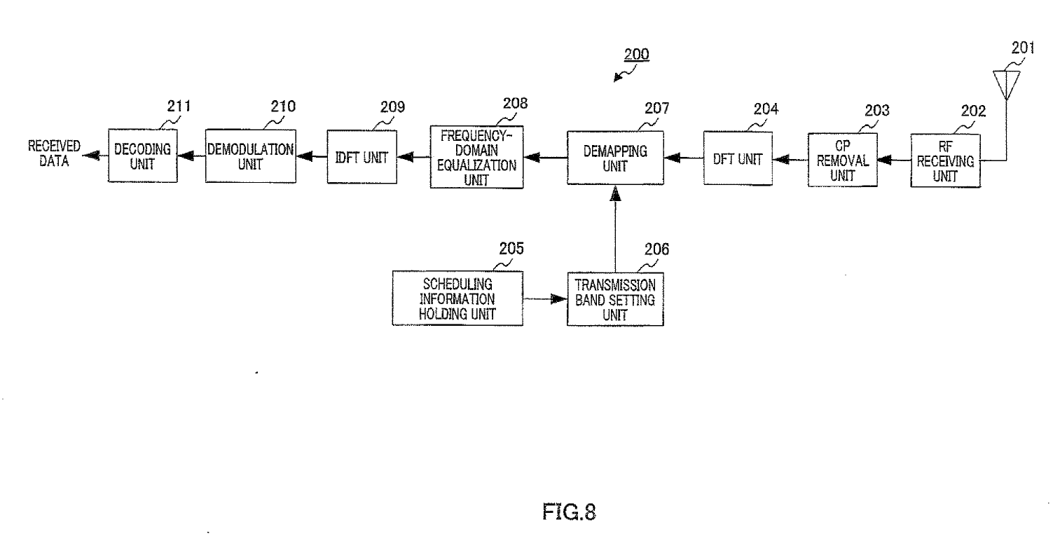

FIG. 8 is a block diagram illustrating the configuration of base station 200 according to Embodiment 1 of the present invention. The configuration of base station 200 will now be described with reference to FIG. 8.

RF reception unit 202 receives signals transmitted from the terminals through antenna 201, performs reception processing such as down-conversion and A/D conversion for the received signals, and outputs the signals for which the reception processing is performed to CP removal unit 203.

CP removal unit 203 removes the CP components added at the head of the reception signals output from RF reception unit 202, and outputs the signals to DFT unit 204.

DFT unit 204 performs DFT processing for the received signals from CP removal unit 203 to transform them into frequency-domain signals, and outputs the signals transformed into the frequency domain to demapping unit 207.

Scheduling information holding unit 205 holds the scheduling information which has been sent to the terminals, and outputs the scheduling information of a desired terminal to be received to transmission band setting unit 206,

Similar to transmission band setting unit 105 provided by terminal 100 shown in FIG. 7, transmission band setting unit 206 sets the allocation band information of the desired terminal based on the scheduling information from scheduling information holding unit 205, and notifies demapping unit 207 of the set allocation band information.

Demapping unit 207 as extraction means extracts signals corresponding to the transmission band of the desired terminal from the frequency-domain signals output from DFT unit 204 according to the allocation band information indicated by transmission band setting unit 206, and outputs the extracted signals to frequency-domain equalization unit 208.

Frequency-domain equalization unit 208 performs equalization for the signals from demapping unit 207, and outputs the equalized signals to IDFT unit 209. IDFT unit 209 performs IDFT processing for the signals output from frequency-domain equalization unit 208, and outputs the IDFT-processed signals to demodulation unit 210.

Demodulation unit 210 demodulates the signals output from IDFT unit 209, and outputs the demodulated signals to decoding unit 211. Decoding unit 211 decodes the signals from demodulation unit 210, and extracts the received data.

The operation of transmission band setting unit 105 of terminal 100 described above will now be explained. Allocation boundary setting unit 107 makes the allocation unit boundaries of a plurality of RIVs different from each other, and determines bands where the plurality of bands indicated by RIVs do not overlap as allocation bands. Further details will be described hereinafter.

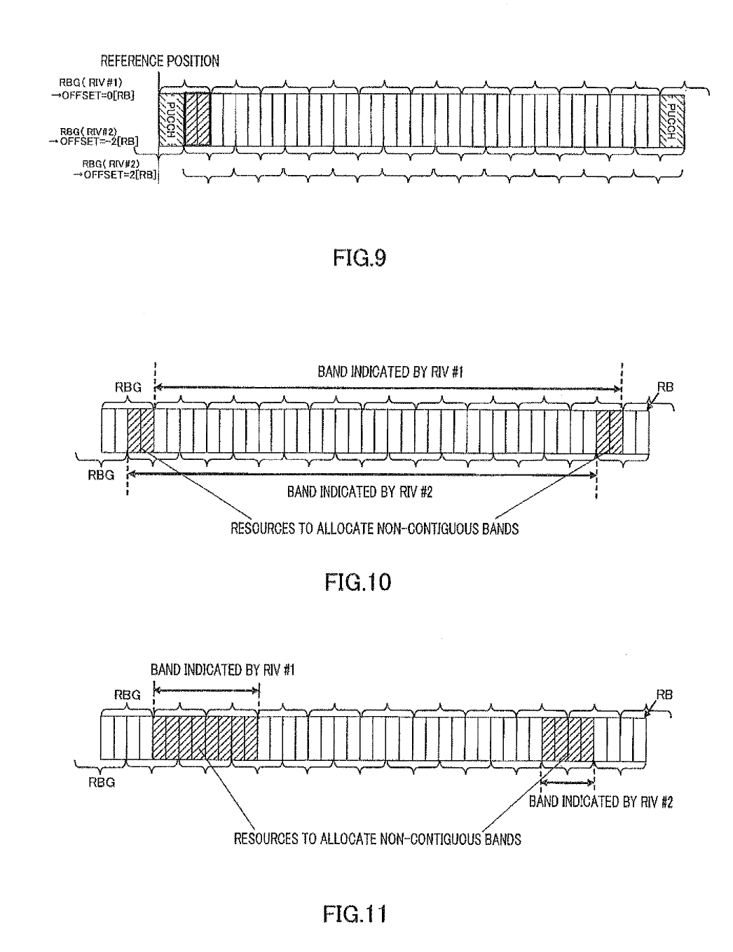

The allocation units (equal to RBG) of the plurality of RIVs are predefined such that boundaries thereof differ from each other. More specifically, as shown in FIG. 9, a different offset (value less than one RBG) is added at a position (reference position) as reference of band indicated by each RIV. For example, when the number of RIVs is equal to 2 (RIV #1 and RIV #2) and 1 RBG=4 RB, the offset of RIV #1 is defined as zero, and the offset of RIV #2 is defined as +2 RB (=+RBG/2) or −2 RB (=−1 RBG/2), with the reference position fixed as shown in FIG. 9. As a result, a different offset is added to the band indicated by each RIV, thereby enabling shifting of allocation unit boundaries of RIVs.

The reference position of the band indicated by each RIV is predetermined by the terminal and the base station. The reference position would be, for example, on the far right or left of the system band, in the band adjacent to PUCCH areas, or on the far tight or left of a SRS (Sounding Reference Signal) transmission area.

The amplitude (set range) of the band that can be indicated by each RIV is also predetermined by the terminal and the base station. Defining the set range of each RIV so as to allocate the overall system band will provide the highest degree of freedom of allocation. Also, defining the set range of each RIV as part of the system band can reduce the number of signaling bits because of decreased RIV values. It is, however, required to define the set range of each RIV so that areas where the set ranges of RIVs overlap are provided in this case.

Transmission band determination unit 108 then derives the band indicated by each RIV according to the definition of RBG described above, and determines bands where the plurality of bands indicated by RIVs do not overlap as allocation bands (transmission bands). That is, assuming that the bands (that are within a range from the start RBG# to the end RBG#) indicated by RIVs are equal to “1”, and the bands other than that are equal to “0”, the bands that are equal to “1” as a result of performing the XOR (exclusive OR) operation on bands indicated by RIVs are determined as the allocation bands.

An allocation band determination method will be described with reference to FIG. 10 and FIG. 11, where the number of RIVs is, for example, equal to 2 (RIV #1 and RIV #2) and 1 RBG=4 RB. When bands indicated by RIVs overlap, as shown in FIG. 10, bands where they do not overlap are determined as the allocation bands, thereby enabling designation of non-contiguous band allocation with a bandwidth of 2 RB (=1 RBG/2). When bands indicated by RIVs do not overlap, as shown in FIG. 11, the indicated bands themselves are determined as the allocation bands in a conventional manner. Thus, in any case, whether or not the bands indicated by RIVs overlap, a single rule of “bands where bands indicated by a plurality of RIVs do not overlap are determined as allocation bands” determines the allocation bands.

Here, even if the band allocation shown in FIG. 10 and FIG. 11 is applied to different terminals, no unnecessary empty resources remain in the system band, and the terminals can be frequency-multiplexed at the same time.

The notification method of indicating non-contiguous band allocation using a plurality of RIVs thus makes allocation unit boundaries of the plurality of RIVs different from each other, and determines bands where the bands indicated by the RIVs do not overlap as the allocation bands, thereby enabling the indication of non-contiguous band allocation including contiguous band allocation of bandwidths less than one RBG, and thus enabling improvement in the usage efficiency of the system frequency resources.

Thus, even if PUCCHs are transmitted at both ends of the system band as shown in FIG. 5, the bands indicated by RIVs are sent with overlapped as shown in FIG. 12, thereby enabling allocation of a band less than one RBG.

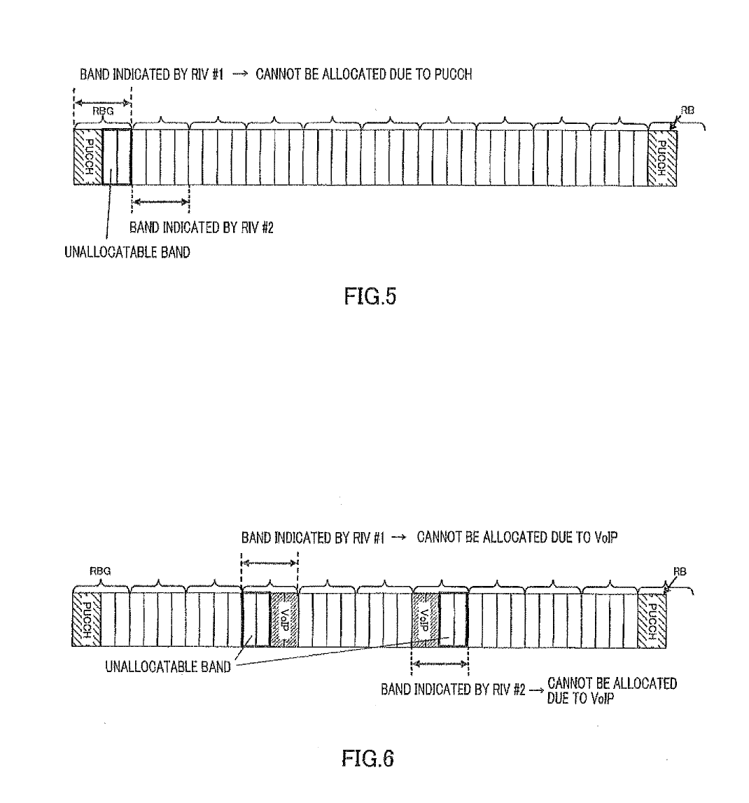

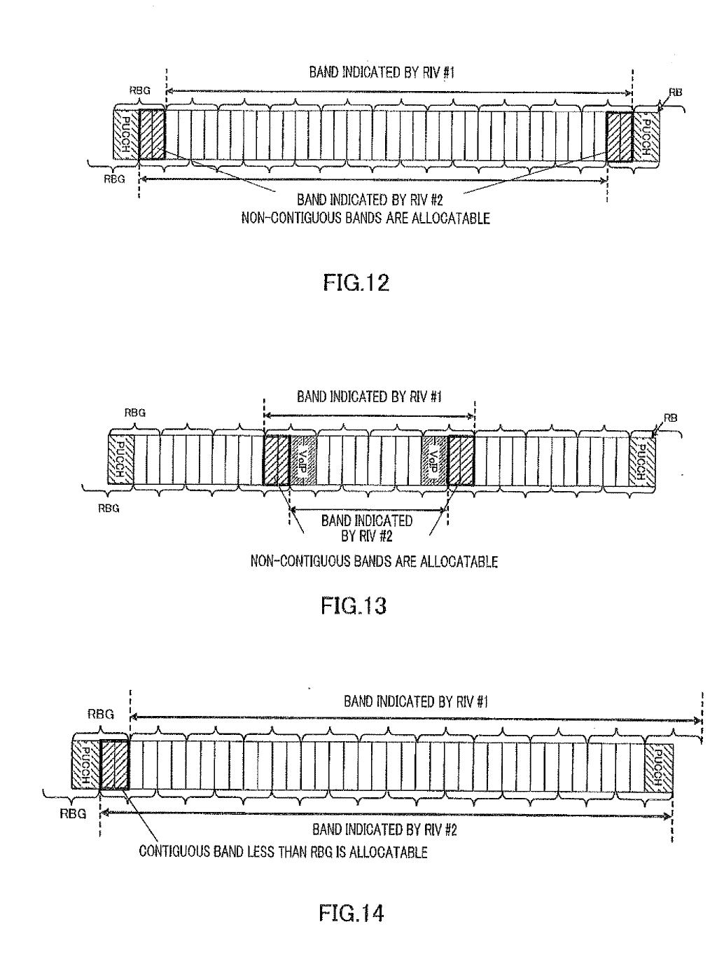

Similarly, even if WO signals are transmitted at the center of the system band as shown in FIG. 6, bands indicated by RIVs are sent with overlapped as shown in FIG. 13, thereby enabling a band less than one RBG.

Thus Embodiment 1 makes the allocation unit boundaries of the plurality of RIVs different from each other, and determines bands where the bands indicated by RIVs do not overlap as the allocation bands. This enables the indication of non-contiguous band allocation including the contiguous band allocation of bandwidths less than one RBG, and thus enabling improvement in the usage efficiency of the system frequency resources, thereby enabling improvement in the system performance.

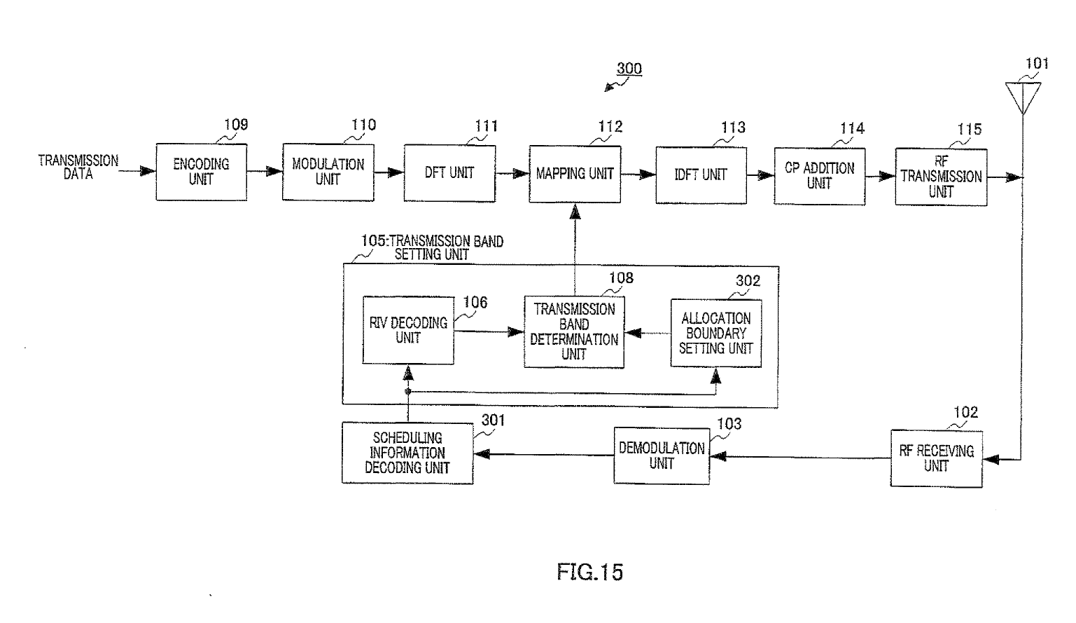

As shown in FIG. 14, if RIV #1 can indicate a band beyond one end of the system band and RIV #2 can also indicate a band to the other end of the system band, the allocation of the number of clusters (the number of contiguous band blocks) less than the number of RIVs can be indicated, thus enabling resource allocation less than one RBG in a single cluster.

Since the resource allocation less than one RBG can be provided over the whole transmission bandwidth, cell-edge terminals with marginal transmission power can reduce performance degradation due to the lack of transmission power. This point is specifically described herein. Acquiring desired reception quality requires an increase in the transmission power of a terminal in proportion to the entire transmission bandwidth of transmission data, while cell-edge terminals located far from the base station need transmission power close to the maximum transmission power for the pathless compensation. Such terminals are subject to the limitation of the maximum transmission power, and are cannot transmit signals with a high transmission bandwidth using the required transmission power. Thus, the shortage of terminal transmission power hinders the acquisition of desired reception quality, and results in the performance degradation. Providing the resource allocation less than one RBG over the whole transmission bandwidth can therefore reduce such performance degradation.

### Embodiment 2

FIG. 15 is a block diagram illustrating the configuration of terminal 300 according to Embodiment 2 of the present invention, FIG. 15 differs from FIG. 7 in that scheduling information decoding unit 104 and allocation boundary setting unit 107 are replaced with scheduling information decoding unit 301 and allocation boundary setting unit 302, respectively.

Scheduling information decoding unit 301 decodes scheduling information output from demodulation unit 103, and outputs a plurality of RIVs included in the decoded scheduling information to RIV decoding unit 106 of transmission band setting unit 105. Scheduling information decoding unit 301 also outputs offset information that determines the allocation unit boundaries of each RIV included in the scheduling information from demodulation unit 103 to allocation boundary setting unit 302.

Allocation boundary setting unit 302 determines the allocation unit boundaries of each RIV based on the offset information from scheduling information decoding unit 301, and outputs the determined allocation unit boundaries of each RIV to transmission band determination unit 108.

The configuration of the base station according to Embodiment 2 of the present invention is similar to the configuration according to Embodiment 1 shown in FIG. 8, except that the transmission band setting unit has a different function. The transmission band setting unit is similar to transmission band setting unit 105 provided by terminal 300 shown in FIG. 15.

The operation of transmission band setting unit 105 of terminal 300 described above will now be described. The base station first notifies terminal 300 of the offset information of one bit indicating whether or not the allocation unit boundaries of a plurality of RIVs are made different as the scheduling information. Terminal 300 determines the allocation unit boundaries of each RIV in allocation boundary setting unit 302 of transmission band setting unit 105 based on the offset information.

When the offset information indicates that the boundaries are made different, allocation boundary setting unit 302 makes the boundaries different from each other by adding a predetermined offset to the allocation unit boundaries of each RIV. For example, when the number of RIVs is equal to 2 (RIV #1 and RIV #2) and 1 RBG=4 RB, the offset of RIV #1 is defined as zero, and the offset of RIV #2 is defined as +2 RB (=+RBG/2) or −2 RB (=−1 RBG/2), as shown in FIG. 9. As a result, the allocation unit boundaries of RIVs are shifted, thereby enabling the band allocation of RBG/2 as described in Embodiment 1.

On the other hand, when the offset information indicates that the boundaries are not made different, allocation boundary setting unit 302 aligns boundaries without addition of the offsets to the allocation unit boundaries of each RIV.

After determining the allocation boundaries, transmission band setting unit 105 performs similar processing as in Embodiment 1, i.e., determines bands where the bands indicated by a plurality of RIVs do not overlap as allocation bands, and outputs the determined allocation band information to mapping unit 112.

The amount of offset may be sent as the offset information. While the number of bits to be sent increases, the degree of freedom of frequency scheduling improves.

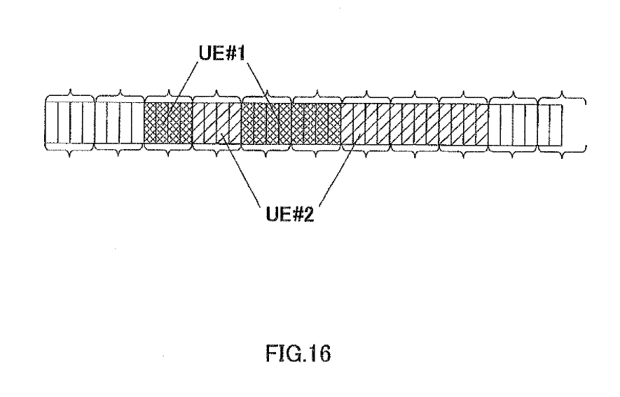

Here, the base station sets, according to the situation, the offset information indicating whether or not allocation unit boundaries of RIVs are made different. That is, when the system band has a large number of contiguous empty resources, aligning the allocation unit boundaries of the plurality of RIVs of each terminal as shown in FIG. 16 facilitates the frequency scheduling of the terminals in a cell using non-contiguous band allocation. In this manner, the frequency scheduling method can easily prevent the occurrence of unnecessary empty resources. On the other hand, when the system band does not have a large number of contiguous empty resources, making the allocation unit boundaries of RIVs as shown in Embodiment 1 can improve the usage efficiency of the system frequency resources.

Thus, Embodiment 2 sets whether or not the allocation unit boundaries of each RIV are made different according to the number of contiguous empty resources existing in the system band. When the system band has a large number of contiguous empty resources, aligning the allocation unit boundaries of the plurality of RIVs of each terminal can facilitate the frequency scheduling of the terminals in a cell using the non-contiguous band allocation, thereby enabling prevention of the occurrence of unnecessary empty resources.

### Embodiment 3

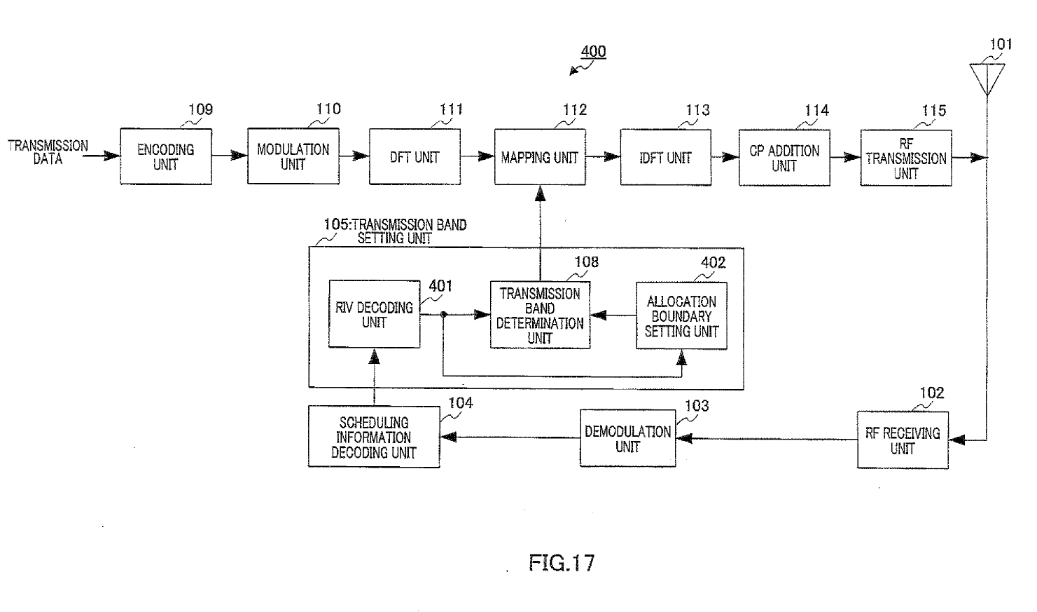

FIG. 17 is a block diagram illustrating the configuration of terminal 400 according to Embodiment 3 of the present invention. FIG. 17 differs from FIG. 7 in that RIV decoding unit 106 and allocation boundary setting unit 107 are replaced with RIV decoding unit 401 and allocation boundary setting unit 402, respectively.

RIV decoding unit 401 decodes the start RBG# and the end RBG# indicated by each RIV output from scheduling information decoding unit 104 based on the RIV tree shown in FIG. 1, and outputs the decoded start RBG# and end RBG# to allocation boundary setting unit 402 and transmission band determination unit 108.

Allocation boundary setting unit 402 determines the allocation unit boundaries of each RIV based on the start RBG# and the end RBG# output from RIV decoding unit 401, and outputs the determined allocation unit boundaries of each RIV to transmission band determination unit 108.

The configuration of the base station according to Embodiment 3 of the present invention is similar to the configuration of Embodiment 1 shown in FIG. 8, except that the transmission band setting unit has a different function. The transmission band setting unit is similar to transmission band setting unit 105 provided by terminal 400 shown in FIG. 17.

The operation of transmission band setting unit 105 of terminal 400 described above will now be described. Allocation boundary setting unit 402 of transmission band setting unit 105 determines whether making allocation unit boundaries of RIVs different or not depending on whether ranges from the start RBG#s to the end RBG#s of RIVs overlap with each other or not. That is, the offset information is defined according to whether the respective ranges of the RBG numbers indicated by RIVs overlap with each other.

When the ranges of the RBG numbers indicated by RIVs overlap to each other, a predetermined offset is added to the allocation unit boundaries of each RIV to make the boundaries different. Similarly to Embodiment 1 and Embodiment 2, the method of making the boundaries different to each other is to add a predetermined amount of offset (less than one RBG) to the allocation unit boundaries of each RIV.

In contrast, when the ranges of the RBG numbers indicated by RIVs do not overlap with each other, the allocation unit boundaries of RIVs are aligned (no offsets are added).

After thus determining the allocation boundaries, transmission band setting unit performs similar processing as in Embodiment 1, i.e., determines bands where the bands indicated by a plurality of RIVs do not overlap, as the allocation bands, and outputs the determined allocation band information to the mapping unit.

Thus, notice of the offset information to be sent depending on whether the ranges of the RBG numbers indicated by RIVs overlap with each other or not can have the similar effect as Embodiment 2 without additional signaling. That means, when the system band has a large number of contiguous empty resources, aligning the allocation unit boundaries of the plurality of RIVs of each terminal facilitates the frequency scheduling of the terminals in a cell using the non-contiguous band allocation, thereby enabling prevention of the occurrence of the unnecessary empty resources.

Thus, Embodiment 3 sends the offset information depending on whether the ranges of the RBG numbers indicated by RIVs overlap with each other or not, thereby making it possible to set whether the allocation unit boundaries of RIVs are made different to each other or not according to the number of the contiguous empty resources existing in the system band, without additional signaling.

### Embodiment 4

The configuration of terminals and the configuration of a base station according to Embodiment 4 of the present invention are similar to the corresponding configurations according to Embodiment 1 shown in FIG. 7 and FIG. 8, except that a transmission band setting unit has a different function. Therefore, the transmission band setting unit will now be described.

Here, the number of signaling bits necessary to send RIVs is described, Assuming the total number of RBG#s indicating allocation bandwidths that can be indicated by RIVs to be N_{RBG}, the number S of the signaling bits necessary to send a piece of RIV information is represented by the following Equation 1:

S[bit]=Roundup (log₂ (N_{RBG}(N_{RBG}+1)/2)) (Equation 1)

In Equation 1, “Roundup ( )” indicates the process of rounding up a decimal value in the parentheses. Equation 1 shows that the larger N_{RBG} is, the more the number S of the signaling bits increases.

Thus, as shown in FIG. 18, limiting the allocation bandwidths that can be indicated by RIVs below the system bandwidth would decrease the N_{RBG} and reduce the number S of the signaling bits. In FIG. 18, there is a limit that RIV #1 and RIV #2 cannot indicate the far right and left of the system band, respectively.

If the allocation bandwidths that can be indicated by RIVs are limited to the system bandwidth or less to reduce the signaling bits as described above, the band less than one RBG cannot be allocated in the band where bands indicated by RIVs do not overlap. That is, if the allocation bandwidths that can be indicated by RIVs are limited as shown in FIG. 18, a band less than one RBG cannot be allocated in the both ends of the system band.

In spite of this assumption, since PUCCHs or VoIP signals are generally allocated in the both ends of the system band, small empty resources readily occur therein. The small empty resources occurring in the both ends of the system band cannot be allocated and not effectively used as a result.

If the allocation bandwidths that can be indicated by RIVs are limited to the system band or less, transmission band determination unit 108 adopts a band that cannot he indicated by RIVs as the central area of the system band. Transmission band determination unit 108 also cyclically shifts RBG# indicated by each RIV in the system band, where the definition of RIV is shared among the terminals and the base stations by being predefined in the system or by being defined at each base station.

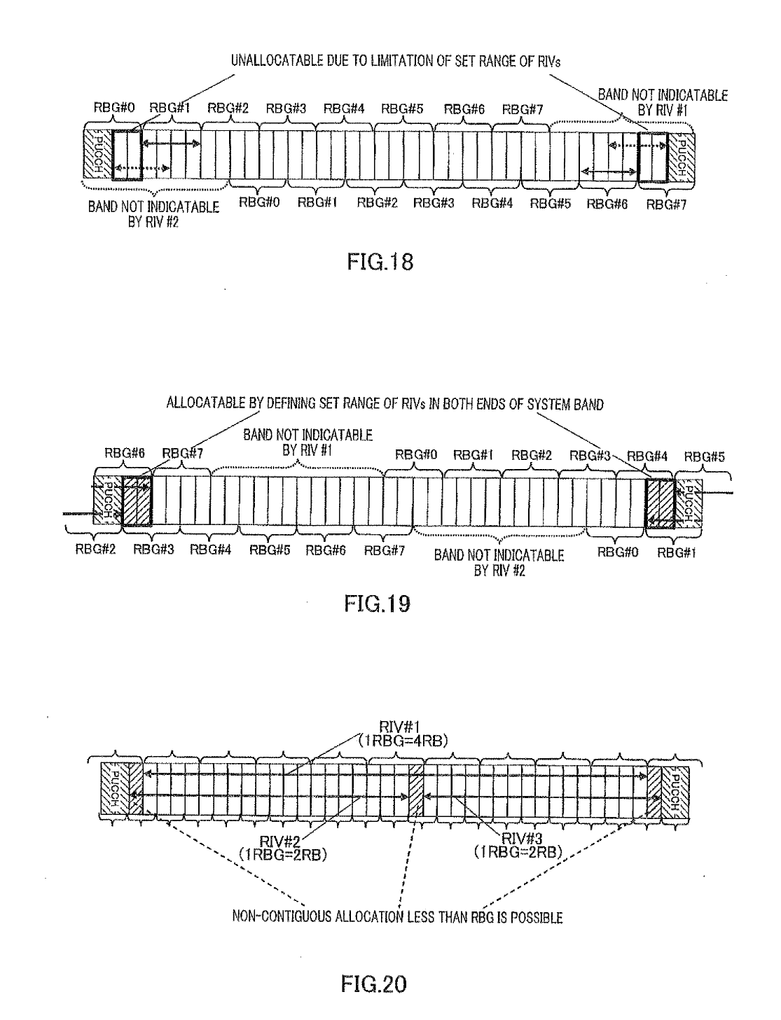

FIG. 19 illustrates an example of the RIV definition described above. The band that cannot be indicated by each RIV is set in the central area of the system baud, and each RIV can indicate the corresponding end of the system band. For example, the indications beyond the system band such as a start RBG=5 and an end RBG=6 of RIV #1 and a start RBG=1 and an end RBG=2 of RIV #2 are made by cyclically shifting RBG#s in the system band, thereby indicating RBGs in the both ends of the system baud.

This can indicate the both ends of the system band where a large number of small empty resources occur using RIVs even if the allocation bandwidths that can be indicated by RIVs are limited below the system hand, thus enabling improvement in the usage efficiency of the system frequency resources without increasing the number of the signaling bits.

Thus, according to Embodiment 4, if the allocation bandwidths that can be indicated by RIVs are limited to the system band or less, the band that cannot be indicated by RIVs is adopted as the central area of the system band, and RBG# (set range of RIV) indicated by each RIV is cyclically shifted in the system band, thereby making it possible to indicate the both ends of the system band using each RIV and thus to improve the usage efficiency of the system frequency resources.

Here, the above embodiments are described as an example where the number of RIVs to be sent is two. However, the number of RIVs may be three or more. For example, FIG. 20 illustrates non-contiguous band allocation using three RIVs. In FIG. 20, RBG of RIV #1 is equal to 4 RB, and RBGs of RIV #2 and RIV #3 whose set ranges are part of the system band are equal to 2 RB. As described in Embodiment 1, RBG boundaries of RIV #1, RIV #2 and RIV #3 are defined so as to be different from one another. Even if PUCCHs each having the allocation granularity of 1 RB are sent at both ends of the system band, the bands indicated by the. RIVs are sent with overlapped as shown in FIG. 20, thereby allocating a band less than one RBG.

While the present invention is described with reference to hardware in the embodiments, the present invention may be implemented using software.

Each function block employed in the description of each of the aforementioned embodiments are typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Furthermore, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Furthermore, if integrated circuit technology comes out to replace LSI's as a result of the advancement of semiconductor technology or a different technology derived from the semiconductor technology, it is naturally also possible to carry out function block integration using this technology. Application of biotechnology is also possible.

Here, although the antenna is described in the above embodiments, the present invention can be applied to a case where an antenna port is used.

The antenna port refers to a logical antenna that is provided with a single or a plurality of physical antennas. That is, the antenna port does not necessarily refer to a single physical antenna, but may refer to, for example, an array antenna formed of a plurality of antennas.

For example, 3GPP LTE does not define the number of physical antennas that configure the antenna port, but a minimum unit for a base station to transmit a different reference signal.

The antenna port may also be defined as a minimum unit for multiplication of the weight of a precoding vector.

The disclosure of Japanese Patent Application No. 2010-3154, filed on Jan. 8, 2010 including the specification, drawings and abstract, is incorporated herein by reference in its entirely.

### INDUSTRIAL APPLICABILITY

The radio transmission apparatus, the radio reception apparatus, and the band allocation method according to the present invention are applicable, for example, to a mobile communication system such as LTE-Advanced.

### REFERENCE SIGNS LIST

101, 201: Antenna

102, 202: RF reception unit

103, 210: Demodulation unit

104, 301: Scheduling information decoding unit

105, 206: Transmission band setting unit

106, 401: RIV decoding unit

107, 302, 402: Allocation boundary setting unit

108: Transmission band determination unit

109: Encoding unit

110: Modulation unit

111, 204: DFT unit

112: Mapping unit

113, 209: IDFT unit

114: CP addition unit

115: RF transmission unit

203: CP removal unit

205: Scheduling information holding unit

207: Demapping unit

208: Frequency-domain equalization unit

211: Decoding unit

1. A radio transmission apparatus comprising:
a receiver configured to receive a plurality of continuous band allocation information indicating allocation of continuous bands;
a transmission band setting unit configured to set allocation unit boundaries of a plurality of bands allocated using the plurality of continuous band allocation information such that the allocation unit boundaries of the plurality of bands differ from each other, and set a band where the plurality of bands indicated by the plurality of continuous band allocation information do not overlap, as a transmission band based on the different allocation unit boundaries; and
a transmitter configured to transmit transmission data on the set transmission band.

2. The radio transmission apparatus according to claim 1, wherein
the transmission band setting unit allocates the number of dusters less than the number of continuous band allocation information using continuous band allocation information capable of indicating allocation including a band beyond one end of the system band.

3. The radio transmission apparatus according to claim 1, wherein
the transmission band setting unit sets the allocation unit boundaries based on offset information indicating whether or not the allocation unit boundaries are made different.

4. The radio transmission apparatus according to claim 3, wherein
the transmission band setting unit employs information to indicate whether or not the plurality of bands overlap as the offset information.

5. The radio transmission apparatus according to claim 4, wherein
the transmission band setting unit makes the allocation unit boundaries different when the plurality of bands overlap, and aligns the allocation unit boundaries when the plurality of bands do not overlap.

6. The radio transmission apparatus according to claim 1, wherein, the transmission band setting unit sets, when an allocation bandwidth indicatable by the continuous band allocation information is limited to equal to or less than a system bandwidth, a band not indicatable by the continuous band allocation information to a central area of a system band, and cyclically shifts the band indicated by each of the plurality of continuous band allocation information in the system band.

7. A radio reception apparatus comprising:
a receiver configured to receive signals transmitted from a communication counterpart;
a band setting unit configured to set allocation unit boundaries of a plurality of bands allocated using a plurality of continuous band allocation information such that the allocation unit boundaries of the plurality of bands differ from each other, and set a band where the plurality of bands indicated by the plurality of continuous band allocation information do not overlap, as an allocation band based on the different allocation unit boundaries; and
an extractor configured to extract the received signals on the set allocation band.

8. A band allocation method comprising:
setting allocation unit boundaries of a plurality of bands allocated using a plurality of continuous band allocation information indicating continuous band allocation, such that the allocation unit boundaries of the plurality of bands differ from each other; and
determining a band where the plurality of bands indicated by the plurality of continuous band allocation information do not overlap, as a transmission band based on the set allocation unit boundaries.
